(19) United States
(12) Patent Application Publication
(10) Pub. No.: US 2015/0331930 A1
(43) Pub. Date: Nov. 19, 2015

(54) METHOD AND APPARATUS FOR CLASSIFICATION OF MEDIA BASED ON METADATA

(71) Applicant: HERE Global B.V., Veldhoven (NL)

(72) Inventors: Ye XING, Boston, MA (US); Vivek GUPTA, Clarksburg, MD (US); Tao WU, Boston, MA (US)

(73) Assignee: HERE Global B.V., Veldhoven (NL)

(21) Appl. No.: 14/280,146

(22) Filed: May 16, 2014

(51) Int. Cl. G06F 17/30

(52) U.S. Cl. CPC G06F 17/30598; G06F 17/3074; G06F 17/30864; G06F 17/30241; G06F 17/3053

(57) ABSTRACT

An approach is provided for processing and/or facilitating a processing of metadata associated with one or more media items to determine one or more observed values for one or more classification parameters, wherein the one or more classification parameters include, at least in part, a number of captured media items per day, a distance of one or more capture locations from at least one home location, or a combination thereof. The approach involves causing, at least in part, a comparison of the one or more observed values against one or more references values for the one or more classification parameters. The approach also involves causing, at least in part, a classification of the one or more media items as being associated with at least one multi-day event based, at least in part, on the comparison.

### BACKGROUND

Many of today's portable devices, such as mobile devices, provide image/video capture functionality. With the rapid growth of digital cameras and camera-embedded mobile devices, users are becoming less judicious to the number of pictures they take. Since numerous users accumulate large collections of digital media, the ability to organize and locate a particular media when needed, might be a challenge. As a result, accurate classification of digital media is important. At present, service providers sort digital media based on time-based information, media type information etc., but neglects to take into consideration the real travel experiences of the users. One has to realize that the development of services should be led by an understanding of the needs of those people who will use the services, i.e., the users.

### Some Example Embodiments

Therefore, there is a need for an approach for causing a classification of media items into a hierarchical clustering based, at least in part, on metadata, geo-location, or a combination thereof.

According to one embodiment, a method comprises processing and/or facilitating a processing of metadata associated with one or more media items to determine one or more observed values for one or more classification parameters, wherein the one or more classification parameters include, at least in part, a number of captured media items per day, a distance of one or more capture locations from at least one home location, or a combination thereof. The method also comprises causing, at least in part, a comparison of the one or more observed values against one or more references values for the one or more classification parameters. The method further comprises causing, at least in part, a classification of the one or more media items as being associated with at least one multi-day event based, at least in part, on the comparison.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of metadata associated with one or more media items to determine one or more observed values for one or more classification parameters, wherein the one or more classification parameters include, at least in part, a number of captured media items per day, a distance of one or more capture locations from at least one home location, or a combination thereof. The apparatus is also caused to cause, at least in part, a comparison of the one or more observed values against one or more references values for the one or more classification parameters. The apparatus is further caused to cause, at least in part, a classification of the one or more media items as being associated with at least one multi-day event based, at least in part, on the comparison.

According to another embodiment, a computer-readable storage medium carries one or more sequences of one or more instructions which, when executed by one or more processors, cause, at least in part, an apparatus to process and/or facilitate a processing of metadata associated with one or more media items to determine one or more observed values for one or more classification parameters, wherein the one or more classification parameters include, at least in part, a number of captured media items per day, a distance of one or more capture locations from at least one home location, or a combination thereof. The apparatus is also caused to cause, at least in part, a comparison of the one or more observed values against one or more references values for the one or more classification parameters. The apparatus is further caused to cause, at least in part, a classification of the one or more media items as being associated with at least one multi-day event based, at least in part, on the comparison.

According to another embodiment, an apparatus comprises means for processing and/or facilitating a processing of metadata associated with one or more media items to determine one or more observed values for one or more classification parameters, wherein the one or more classification parameters include, at least in part, a number of captured media items per day, a distance of one or more capture locations from at least one home location, or a combination thereof. The apparatus also comprises means for causing, at least in part, a comparison of the one or more observed values against one or more references values for the one or more classification parameters. The apparatus further comprises means for causing, at least in part, a classification of the one or more media items as being associated with at least one multi-day event based, at least in part, on the comparison.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of causing a classification of media items into a hierarchical clustering based, at least in part, on metadata, geo-location, or a combination thereof, according to one embodiment;

FIG. 2 is a diagram of the components of the classification platform 109, according to one embodiment;

FIG. 3 is a flowchart of a process for causing a classification of media items associated with a multi-day event based on processing of their metadata, according to one embodiment;

FIG. 4 is a flowchart of a process for organizing one or more media items based on their geo-location information, according to one embodiment;

FIG. 5 is a flowchart of a process for processing of behavioral pattern data associated with one or more users to determine reference values and/or classification parameters, according to one embodiment;

FIG. 6 is a flowchart of a process for causing hierarchical clustering of the one or more media items, and causing a calculation of one or more statistical metrics, according to one embodiment;

FIG. 7 is a flow diagram that represents the process of personalizing a multi-day trip classifier, according to one embodiment;

FIG. 8 is a diagram that represents the process of detecting a multi-day trip using the metadata associated with one or more images, videos, or a combination thereof, according to one embodiment;

FIG. 9 is a diagram that represents hierarchical clustering of images and/or videos into different albums based on location information, according to one embodiment;

FIGS. 10 A-B are user interface diagrams that represent a scenario wherein the classification platform 109 determines a multi-day trip for at least one user, according to one embodiment;

FIGS. 11 A-B are user interface diagrams that represent a scenario wherein the classification platform 109 determines a single-day trip for at least one user, according to one embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for causing a classification of media items into a hierarchical clustering based, at least in part, on metadata, geo-location, or a combination thereof are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

The proliferation of digital cameras has led to an explosion of digital media. As digital images and/or videos are being created at a rapid rate, sorting them based on user's travel experience presents a significant challenge. In one scenario, users may send a request to group one or more pictures and/or videos taken during a multi-day trip, but the existing service provider cannot detect a multi-day trip without user input. In one example embodiment, a user leaves for a seven days trip with several intermediate stops, for example, Paris, London, and Barcelona. The current service providers can sort the images and/or videos based on temporal information. Therefore, the images and/or videos of the seven days trip may be sorted in seven different albums based on time regardless of the location. As a result, a picture taken in the same city may be sorted into different albums if they were taken at different time frame. Accordingly, the existing service fails to group media from a multi-day trip into one album.

To address this problem, System 100 may cause an automated sorting of digital media based on their metadata. In one scenario, system 100 may detect a multi-day trip by processing the metadata associated with a digital media and may automatically organize the digital media based on their geo-location. In one scenario, System 100 may facilitate automatic grouping of images and/or videos taken during a multi-day trip. The hierarchical clustering of images and/or videos may group images and/or videos taken at different locations, thereby aiding in better organizing and tagging the images and/or videos.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, augmented reality glasses, virtual reality glasses or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as content provisioning services, camera/imaging application, media player applications, social networking applications, location-based service applications, calendar applications, and the like. In one scenario, the applications 103 may include a facial recognition application for automatically identifying or verifying a person from a digital image or a video frame. In another scenario, the applications 103 may include a computer vision system to identify objects in an image or a video. In one embodiment, one of the applications 103 at the UE 101 may act as a client for the classification platform 109 and may perform one or more functions associated with the functions of the classification platform 109 by interacting with the classification platform 109 over the communication network 107.

By way of example, the sensors 105 may be any type of sensor. In certain embodiments, the sensors 105 may include, for example, a global positioning sensor for gathering location data (e.g., GPS), a network detection sensor for detecting wireless signals or receivers for different short-range communications (e.g., Bluetooth, WiFi, Li-Fi, near field communication etc.), temporal information, a camera/imaging sensor for gathering image data, an audio recorder for gathering audio data, and the like. In one embodiment, the sensors 105 may geo-tag or geo-code one or more digital media using a camera with a built-in GPS receiver, wherein geographic coordinates are added to the metadata of the one or more images and/or videos. In one scenario, the sensors 105 may include, light sensors, oriental sensors augmented with height sensor and acceleration sensor, tilt sensors, moisture sensors, pressure sensors, audio sensors (e.g., microphone), etc. In one embodiment, a microphone may be utilized to create geo-tagged audio files.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the classification platform 109 may be a platform with multiple interconnected components. The classification platform 109 may include multiple servers, intelligent networking devices, computing devices, components and corresponding software for causing a classification of media items into a hierarchical clustering based, at least in part, on metadata, geo-location, or a combination thereof. As the existing services sorts the digital media by time, because of which the users need to sort the images and/or videos from a multi-day trip manually. In addition, the users need to manually sort images and/or videos taken from multiple locations. To resolve this issue, the classification platform 109 processes the metadata of the digital media to automatically detect whether the user is on a multi-day trip and may provide a hierarchical clusters based on geo-location of the images and/or videos taken at different locations.

In one embodiment, the classification platform 109 may develop a classifier based on the similarity of users' behavior once they are on a multi-day trip. The classification platform 109 may implement the following features in the proposed classifier:
(a) The classifier to identify multi-day trip can capture the general users' photo shooting behavior in a population;
(b) The classifier may be adaptive and customized to an individual user based on his/her behavior of organizing images and/or videos;
(c) The classifier may provide reasonable inferences in organizing images and/or videos to albums when the images and/or videos do not have geo-location information;
(d) For a multi-day trip, the classifier may cause a hierarchical clustering to organize images and/or videos into different layers based on geo-location; and
(e) For a one-day trip with multiple destinations, the classifier may cause hierarchical clustering of images and/or videos into different layers based on geo-location.

In one scenario, to build an automatic and customized classifier to identify multi-day trip, a general model based on the population is trained and then this general model is adaptively tuned for a particular individual. The general model is built on features which can be aggregated from metadata of images and/or videos, and can capture the users' behavior while on a multi-day trip. The useful and available features are, for example, the number of images and/or videos taken per day, the average distance from users' residence per day, and the standard deviation of the distance from users' residence per day. These features are used by the classifier based on the fact that when a user is on a multi-day trip, he/she is likely to take increased number of images and/or videos, he/she is likely to travel an increased distance away from users' place of residence, and there will be an increased standard deviation of the distance from users' place of residence on the departing and the arriving day.

In one scenario, once the general model is created, it needs to be tuned and customized to individuals since the photo behavior varies among individuals. In this adaptive learning step, the parameters in the general model are needed to be fine-tuned with some input from the users. When applying the general model to a new user, if there is a detected multi-day trip, the system needs the confirmation from the new user. With the feedbacks from the new user, the parameters in the general model may be changed accordingly to build a personalized model. The user needs to provide the feedback (yes or no) for their first couple of trips to build a personalized model. After that, this personalized model can automatically detect multi-day trips. In another scenario, after a multi-day trip classifier identifies the start and end date of the trip, a hierarchical clustering based on location is performed to organize the images and/or videos in different levels. The hierarchical clustering is to put images and/or videos taken closer in location into tentative albums. For the rest of the images and/or videos not taken during a multi-day trip, a hierarchical clustering based on location is performed to organize the images and/or videos in different levels.

In one embodiment, the classification platform 109 may create the database 111 wherein the detected information, for example, media information, location information, may be stored. In another embodiment, the classification platform 109 may store one or more single-day event albums, one or more multi-day event albums, or a combination thereof in database 111. The information may be any multiple types of information that can provide means for aiding in the content provisioning and sharing process.

The services platform 113 may include any type of service. By way of example, the services platform 113 may include content (e.g., audio, video, images, etc.) provisioning services, social networking services, application services, storage services, contextual information determination services, information (e.g., weather, news, etc.) based services, location based services, etc. In one embodiment, the services platform 113 may interact with the UE 101, the classification platform 109 and the content providers 117 to supplement or aid in the processing of the content information to causing a classification of media items into a hierarchical clustering.

By way of example, the services 115 may be an online service that reflects interests and/or activities of users. In one scenario, the services 115 provide representations of each user (e.g., a profile), his/her social links, and a variety of additional information. The services 115 allow users to share media information, location information, activities information, contextual information, historical user information and interests within their individual networks, and provides for data portability. The services 115 may additionally assist in providing the classification platform 109 with relevant content information to cause a classification of media items into a hierarchical clustering.

The content providers 117 may provide content to the UE 101, the classification platform 109, and the services 115 of the services platform 113. The content provided may be any type of content, such as image content, video content, textual content, etc. In one embodiment, the content providers 117 may provide content that may supplement content of the applications 103, the sensors 105, or a combination thereof. By way of example, the content providers 117 may provide content that may aid in causing a classification of media items into hierarchical clusters. In one embodiment, the content providers 117 may also store content associated with the UE 101, the classification platform 109, and the services 115 of the services platform 113. In another embodiment, the content providers 117 may manage access to a central repository of data, and offer a consistent, standard interface to data, such as a repository of users' navigational data content.

By way of example, the UE 101, the classification platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

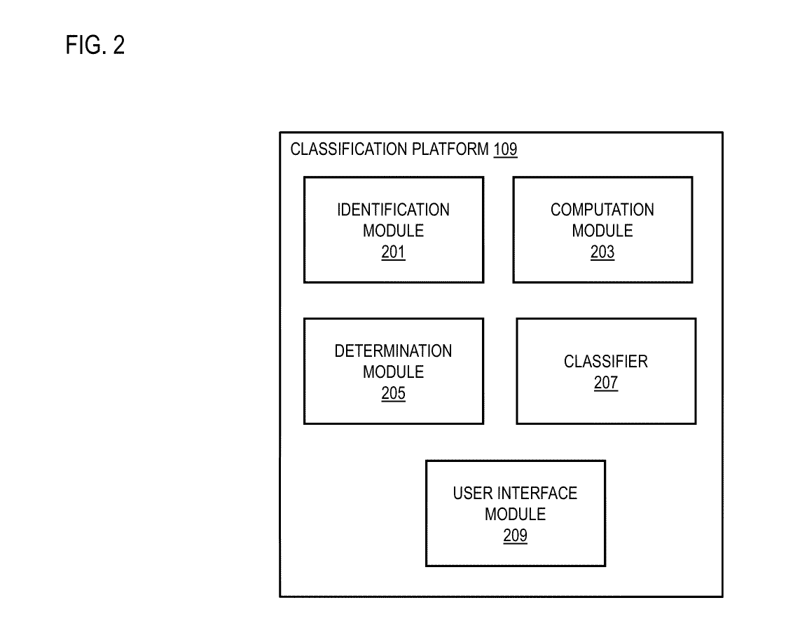

FIG. 2 is a diagram of the components of the classification platform 109, according to one embodiment. By way of example, the classification platform 109 includes one or more components for causing a classification of media items into a hierarchical clustering based, at least in part, on temporal information, geo-location, or a combination thereof. It is contemplated that the functions of these components may be combined in one or more components or performed by other components of equivalent functionality. In this embodiment, the classification platform 109 includes an identification module 201, a computation module 203, a determination module 205, a classifier 207, and a user interface module 209.

In one embodiment, the identification module 201 may receive one or more images, one or more videos, or a combination thereof from one or more users. Then, the identification module 201 may process and/or facilitate a processing of metadata associated with one or more images, one or more videos, or a combination thereof. Subsequently, the identification module 201 may cause, at least in part, an identification of a one-day event, a multi-day event, or a combination thereof based, at least in part, on the processing.

In one embodiment, the computation module 203 may calculate one or more statistical metrics associated with, for instance, user behavior with respect to capturing, sorting, and/or classifying media. By way of example, statistical metrics may include an average of the number of pictures, videos, or a combination thereof taken during a specific time period, an average of the distance towards at least one destination that are calculated based, at least in part, on metadata associated with one or more images, one or more videos, or a combination thereof. Other examples of statistical metrics may include a standard deviation, a variance, or a combination thereof that are calculated based, at least in part, on metadata associated with one or more images, one or more videos, or a combination thereof to categorize a one-day trip, a multi-day trip, or a combination thereof. It is noted that the statistical metrics described above are provided as examples, and are not intended as limitations to the types of statistical metrics that are applicable to the various embodiments described herein.

In one embodiment, the determination module 205 may determine behavioral pattern for at least one user at the time of taking at least one picture, at least one video, or a combination thereof. In another embodiment, the determination module 205 may determine one or more images, one or more videos, or a combination thereof taken at different locations. In one scenario, the determination module 205 may determine reasonable inferences in organizing one or more images, one or more videos, or a combination thereof without location information. In a further embodiment, the determination module 205 may determine temporal information for at least one event, wherein temporal information includes the start date for an event, the end date for an event, or a combination thereof. In one embodiment, the determination module 205 may determining other images, other videos, or a combination thereof taken outside the start date and the end date of an event.

In one embodiment, the classifier 207 may cause, at least in part, a classification of one or more images, one or more videos, or a combination thereof into a hierarchical clustering based, at least in part, on metadata, location information, or a combination thereof. In another embodiment, the classifier 207 may receive data from the determination module 205 to classify one or more images, one or more videos, or a combination thereof based, at least in part, on similarity of behavioral pattern of at least one user. In addition, the classifier 207 may cause, at least in part, an adaptation of a classification to at least one user behavior of organizing one or more images, one or more videos, or a combination thereof. In a further embodiment, the classifier 207 may receive data from the determination module 205 to cause a hierarchical clustering of one or more images, one or more videos, or a combination thereof based, at least in part, on location information, temporal information, or a combination thereof.

In one embodiment, the user interface module 209 employs various application programming interfaces (APIs) or other function calls corresponding to the applications 103 of the UE 101, thus enabling the display of graphics primitives such as menus, data entry fields, etc., for generating the user interface elements. By way of example, the user interface module 209 generates the interface in response to APIs or other function calls corresponding to the browser application of the UE 101, thus enabling the display of graphics primitives. In another embodiment, the user interface module 209 causes a presentation of one or more images, one or more videos, or a combination thereof in their relevant compilations, thereby making it convenient for user to locate them.

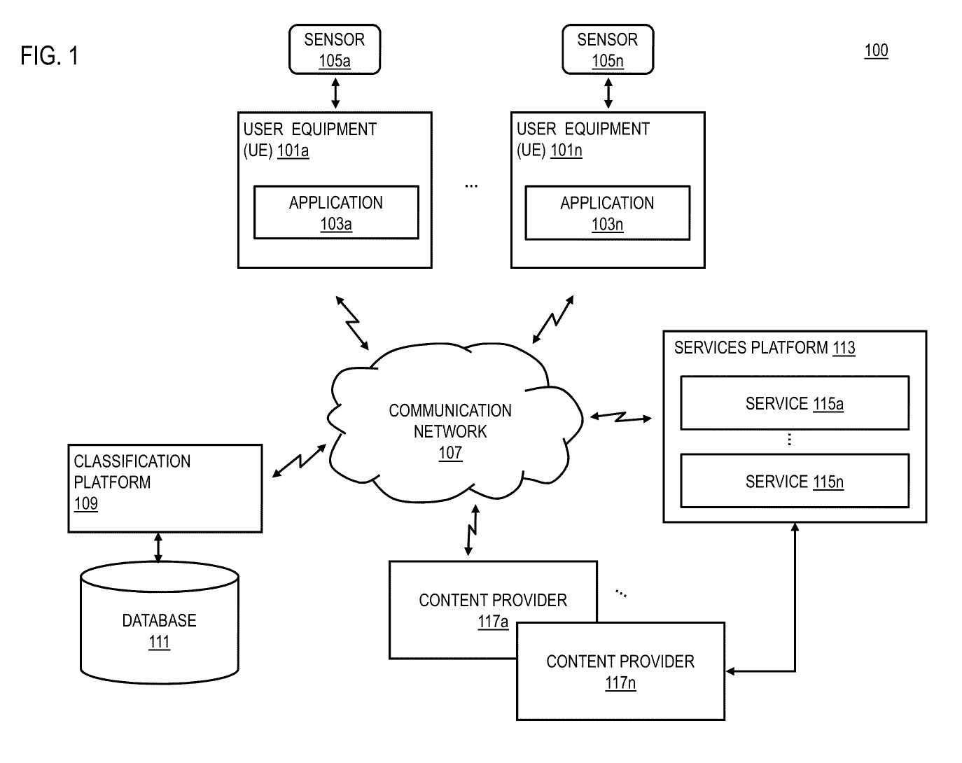

The above presented modules and components of the classification platform 109 can be implemented in hardware, firmware, software, or a combination thereof. Though depicted as a separate entity in FIG. 1, it is contemplated that the classification platform 109 may be implemented for direct operation by respective UE 101. As such, the classification platform 109 may generate direct signal inputs by way of the operating system of the UE 101 for interacting with the applications 103. In another embodiment, one or more of the modules 201-209 may be implemented for operation by respective UEs, as a classification platform 109. Still further, the classification platform 109 may be integrated for direct operation with the services 115, such as in the form of a widget or applet, in accordance with an information and/or subscriber sharing arrangement. The various executions presented herein contemplate any and all arrangements and models.

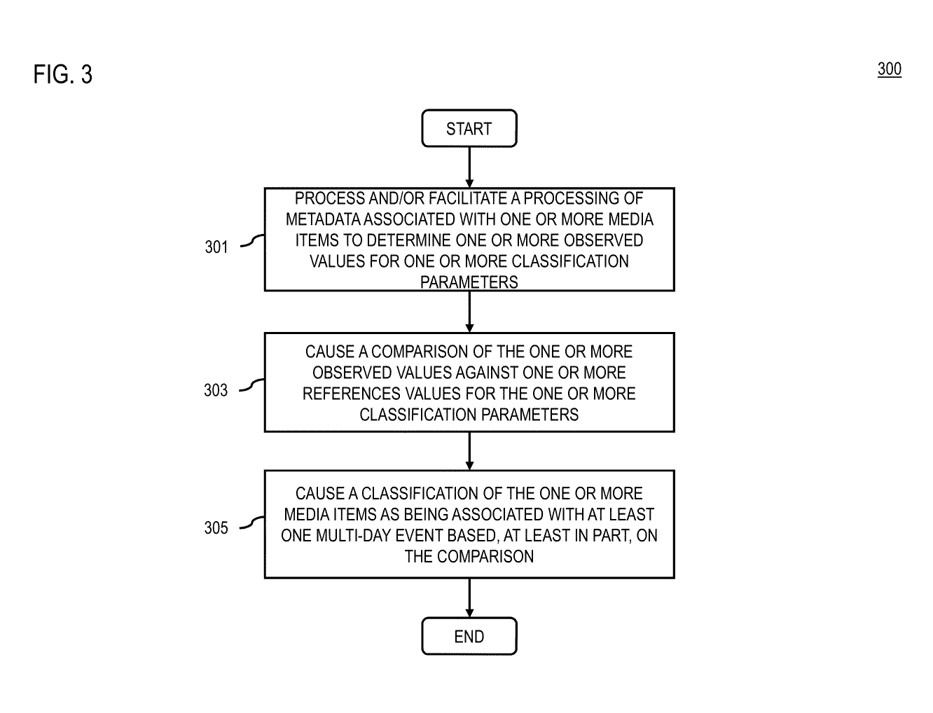

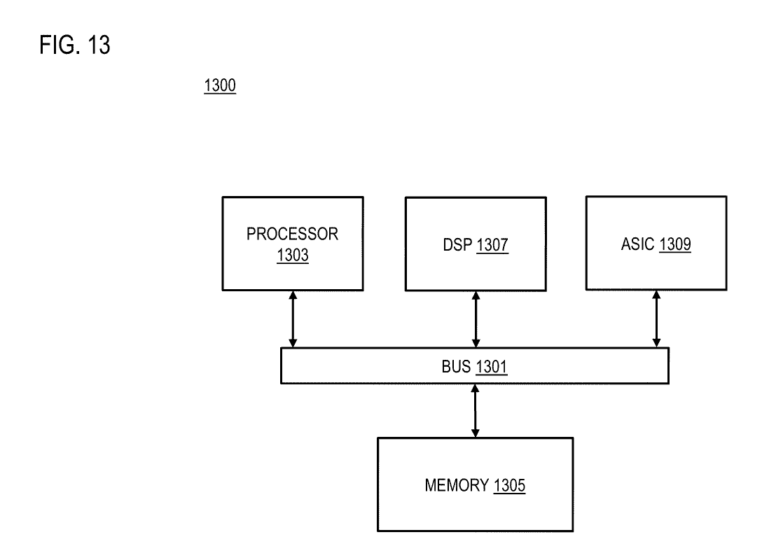

FIG. 3 is a flowchart of a process for causing a classification of media items associated with a multi-day event based on processing of their metadata, according to one embodiment. In one embodiment, the classification platform 109 performs the process 300 and is implemented in, for instance, a chip set including a processor and a memory as shown in FIG. 13.

In step 301, the classification platform 109 may processes and/or facilitate a processing of metadata associated with one or more media items to determine one or more observed values for one or more classification parameters, wherein the one or more classification parameters include, at least in part, a number of captured media items per day, a distance of one or more capture locations from at least one home location, or a combination thereof. In one scenario, different parameters may be used for calculating the average number of captured media items, for example, a median number of captured media items, a weighed number of captured media items, a clustered number of captured media items and so on. In one example embodiment, a user may take more pictures during his/her trip as compared to any other normal day. The classification platform 109 may calculate an average for the number of pictures taken by a user during a specific time period to determine whether a user is on a multi-day trip. In another scenario, different parameters may be used for calculating the distance of the captured locations, for example, a median distance, a weighed distance, a clustered distance and so on. In one example embodiment, a user may travel more during his/her trip as compared to any other normal day. The classification platform 109 may calculate an average distance from the place of reference of the user (e.g. users' home) to determine whether the user is on a multi-day trip. In one embodiment, the classification of the one or more media items further classifies the one or more media items as being associated with one or more sub-events of the at least one multi-day event based, at least in part, on the comparison. In one example embodiment, the classification platform 109 may classify one or more media items based on location granularity, for example, media items may be sorted based on the regions, cities, neighborhoods, streets, among other. In another example embodiment, a family of five goes on a multi-day trip to a city. Each family member may be visiting different point of interest within the city, and at the end of their trip they may come together to process their media items for proper allocation. The classification platform 109 may sort the images and/or videos taken during the multi-day trip in an album, and the album may have sub-categories wherein the one or more images and/or videos may be sorted based, at least in part, on geo-location, event information etc.

In step 303, the classification platform 109 may cause, at least in part, a comparison of the one or more observed values against one or more references values for the one or more classification parameters. In one scenario, the classification platform 109 may determine an observed value by processing the metadata associated with one or more images and/or videos. The observed value may be the average number of pictures taken by a user in a day, average distance between the user's home and the destination, the standard deviation of the distance from users' residence per day. Then, the classification platform 109 causes a comparison of the observed values with the reference values. In one scenario, the reference values may be the average number of pictures taken by the general population in a day, average distance travelled by general population between their home and their destination, standard deviation distance.

In step 305, the classification platform 109 may cause, at least in part, a classification of the one or more media items as being associated with at least one multi-day event based, at least in part, on the comparison. In one scenario, the classification platform 109 causes classification of one or more images, one or more videos, or a combination thereof into a hierarchical clustering based, at least in part, on metadata, location information, or a combination thereof.

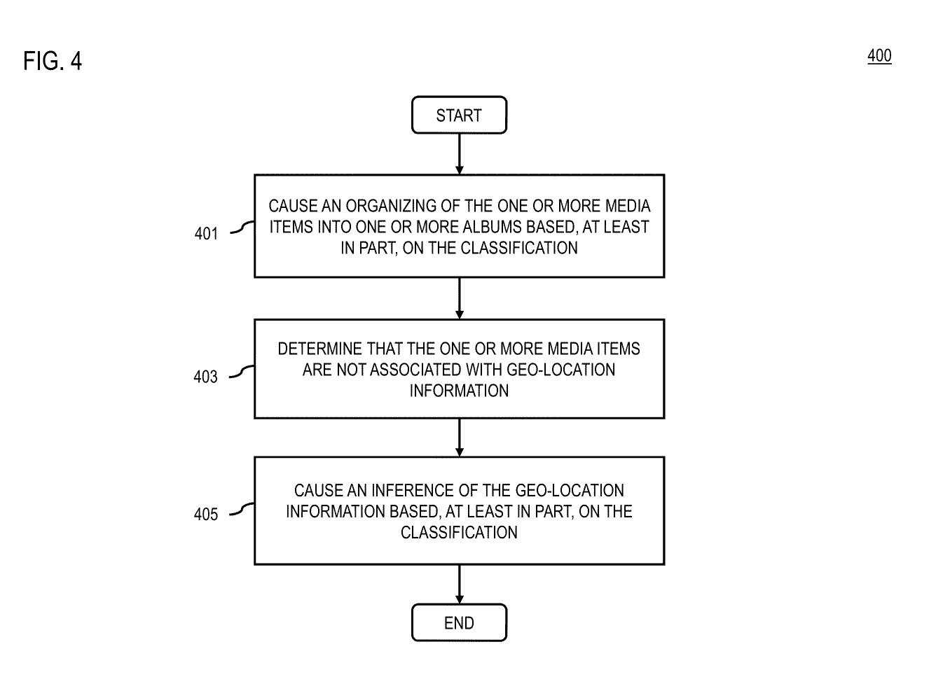

FIG. 4 is a flowchart of a process for organizing one or more media items based on their geo-location information, according to one embodiment. In one embodiment, the classification platform 109 performs the process 400 and is implemented in, for instance, a chip set including a processor and a memory as shown in FIG. 13.

In step 401, the classification platform 109 may cause, at least in part, an organizing of the one or more media items into one or more albums based, at least in part, on the classification, wherein the one or more albums are associated with the at least one multi-day event. In one scenario, the classification platform 109 may determine one or more images, one or more videos, or a combination thereof taken at different locations. In another scenario, the classification platform 109 may determine temporal information for one or more images and/or videos. Subsequently, the classification platform 109 may organize one or more images, one or more videos, or a combination thereof based on geo-location, temporal information, or a combination thereof.

In step 403, the classification platform 109 may determine that the one or more media items are not associated with geo-location information. In one scenario, one or more UE 101 may not be equipped to geo-tag media items to provide geographic information. The classification platform 109 may process the metadata associated with such media items to determine any additional information that might assist in their classification.

In step 405, the classification platform 109 may cause, at least in part, an inference of the geo-location information based, at least in part, on the classification, wherein the organizing of the one or more media items is further based, at least in part, on the inference of the geo-location information. In one scenario, a user may be on a multi-day trip. The UE 101 associated with the user may not be equipped to provide geo-location information for the media items, nevertheless the classification platform 109 may determine reasonable inferences in organizing the media items. In such scenario, the classification platform 109 may classify media items based, at least in part, on time-based information, location information of the UE 101 detected via one or more sensors 105, facial recognition in an image or a video via application 103, computer vision system to identify objects in an image or a video via application 103, user inputs, etc.

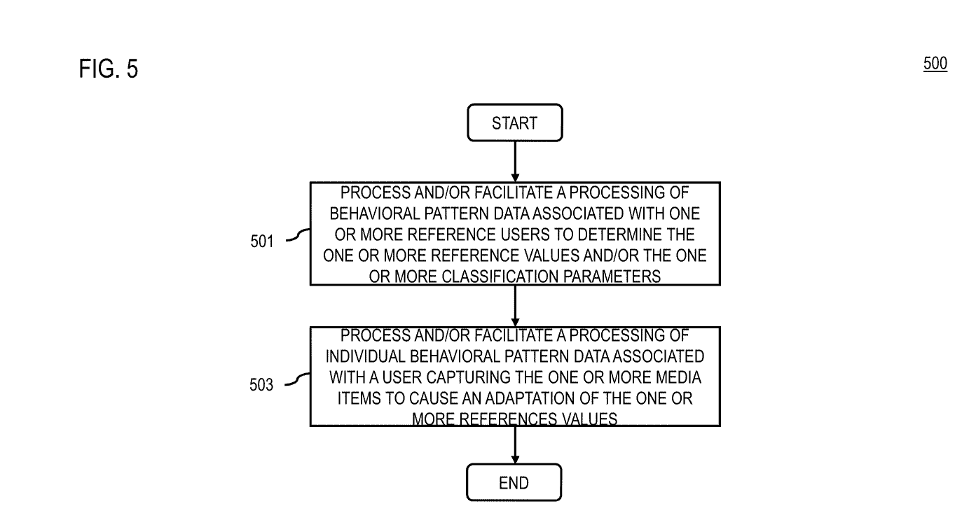

FIG. 5 is a flowchart of a process for processing of behavioral pattern data associated with one or more users to determine reference values and/or classification parameters, according to one embodiment. In one embodiment, the classification platform 109 performs the process 500 and is implemented in, for instance, a chip set including a processor and a memory as shown in FIG. 13.

In step 501, the classification platform 109 may process and/or facilitate a processing of behavioral pattern data associated with one or more reference users to determine the one or more reference values, the one or more classification parameters or a combination thereof, wherein the one or more references are engaged in at least one reference multi-day trip. In one scenario, the classification platform 109 may determine behavioral pattern for at least one user at the time of taking at least one picture, at least one video, or a combination thereof. Then, the classification platform 109 may classify one or more images, one or more videos, or a combination thereof based, at least in part, on similarity of behavioral pattern of at least one user.

In step 503, the classification platform 109 may process and/or facilitate a processing of individual behavioral pattern data associated with at least one user capturing the one or more media items to cause, at least in part, an adaptation of the one or more references values, wherein the comparison of the one or more observed values, the classification of the one or more media items, or a combination thereof is further based, at least in part, on the adaption of the one or more reference values. In one embodiment, the individual behavioral pattern data relate, at least in part, to a media capturing behavior, a media organizing behavior, or a combination thereof.

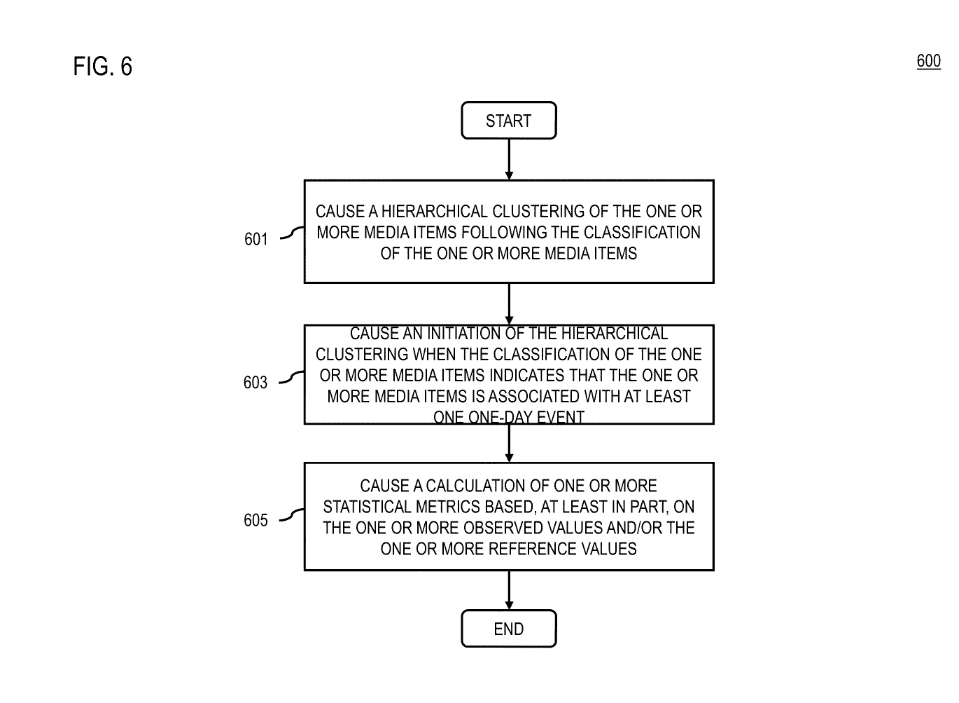

FIG. 6 is a flowchart of a process for causing hierarchical clustering of the one or more media items, and causing a calculation of one or more statistical metrics, according to one embodiment. In one embodiment, the classification platform 109 performs the process 600 and is implemented in, for instance, a chip set including a processor and a memory as shown in FIG. 13.

In step 601, the classification platform 109 may cause, at least in part, a hierarchical clustering of the one or more media items following the classification of the one or more media items. In one embodiment, the hierarchical clustering is based, at least in part, on one or more contextual parameters. In one embodiment, the one or more contextual parameters include, at least in part, a geo-location parameter, a temporal parameter, or a combination thereof. In one scenario, the classification platform 109 may determine temporal information for at least one event, wherein the temporal information includes the start date for an event, the end date for an event, or a combination thereof. Subsequently, the classification platform 109 may cause a hierarchical clustering of media items into different levels based on geo-location.

In step 603, the classification platform 109 may cause, at least in part, an initiation of the hierarchical clustering when the classification of the one or more media items indicates that the one or more media items is associated with at least one one-day event. In one scenario, the classification platform 109 identifies a one-day event based, at least in part, on the processing of the metadata associated with the one or more media items. In another scenario, the classification platform 109 may detect one or more user input to cause a modification of one or more parameters to detect a one-day event.

In step 605, the classification platform 109 may cause, at least in part, a calculation of one or more statistical metrics based, at least in part, on the one or more observed values, the one or more reference values, or a combination thereof. In one embodiment, the comparison of the one or more observed values, the classification of the one or more media items, or a combination thereof is further based, at least in part, on the one or more statistical metrics. In another embodiment, the one or more statistical metrics include, at least in part, a standard deviation, a variance, or a combination thereof. In one scenario, the classification platform 109 may cause a calculation of a standard deviation, a variance, or a combination thereof based, at least in part, on metadata associated with one or more media items. In another scenario, the classification platform may calculate the standard deviation of distance from user's residence to the at least one destination.

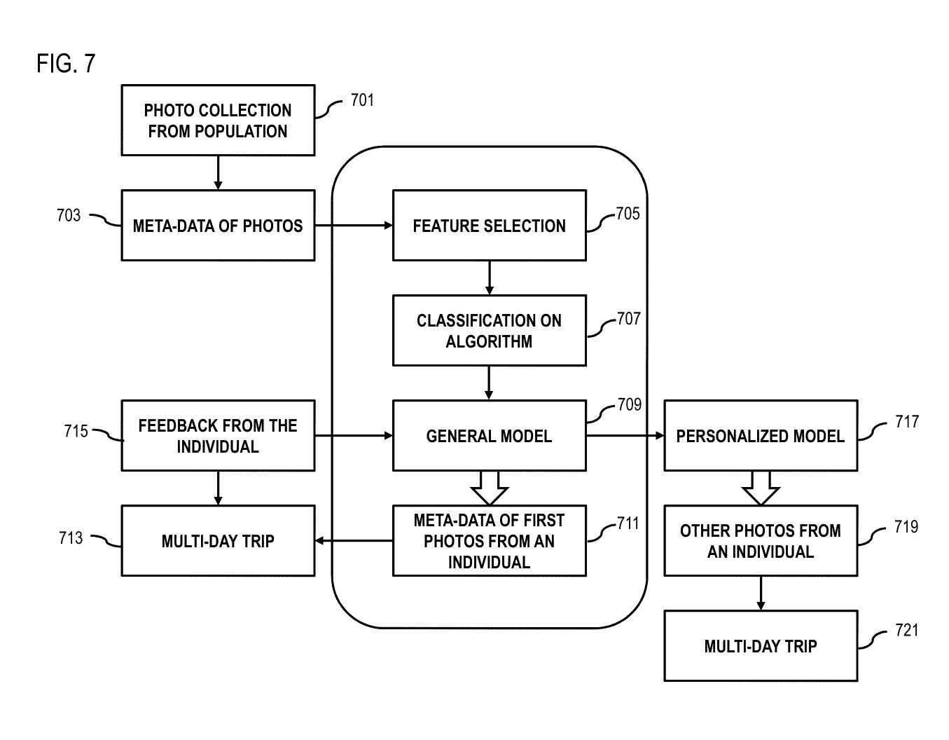

FIG. 7 is a flow diagram that represents the process of personalizing a multi-day trip classifier, according to one embodiment. In one embodiment, a multi-day trip classifier may be based on the general population (a population based module) [701], wherein metadata of one or more images and/or videos associated with the population at large may be processed [703] to cause a classification. In one scenario, the classification platform 109 may cause a selection of one or more images and/or videos to cause a classification based, at least in part, on metadata, location information, temporal information, or a combination thereof [705]. In one scenario, the classification platform 109 may implement an algorithm to sort the one or more images and/or videos [707], wherein the algorithm may include calculating average number of pictures and/or videos taken in a day, average distance from a reference POI towards at least one destination, standard deviation to infer categorizing at least one or more multi-day trip, or a combination thereof. In one scenario, a new user may be taking pictures in a manner that is distinct from other members of the general population. As a result, an adjustment in the general population based module [709] is required to make it more customized for the new user. In one scenario, once the classification platform 109 receives metadata from the images and/or videos associated with the new user [711], it may use the general population based module to detect whether it is a multi-day trip or not [713]. Subsequently, the classification platform 109 may receive feedback from the new user on whether the detected result is correct [715]. If the result is correct then the classification platform 109 may use the general population based module, however, if the new user gives a feedback stating that the sorting is incorrect then the classification platform 109 may customize the general population based module to lower the threshold [717], or change at least one feature to personalize it to the at least one user [717]. In such manner, the classification platform 109 may receive other images from the user [719] which is sorted as images from a multi-day trip [721].

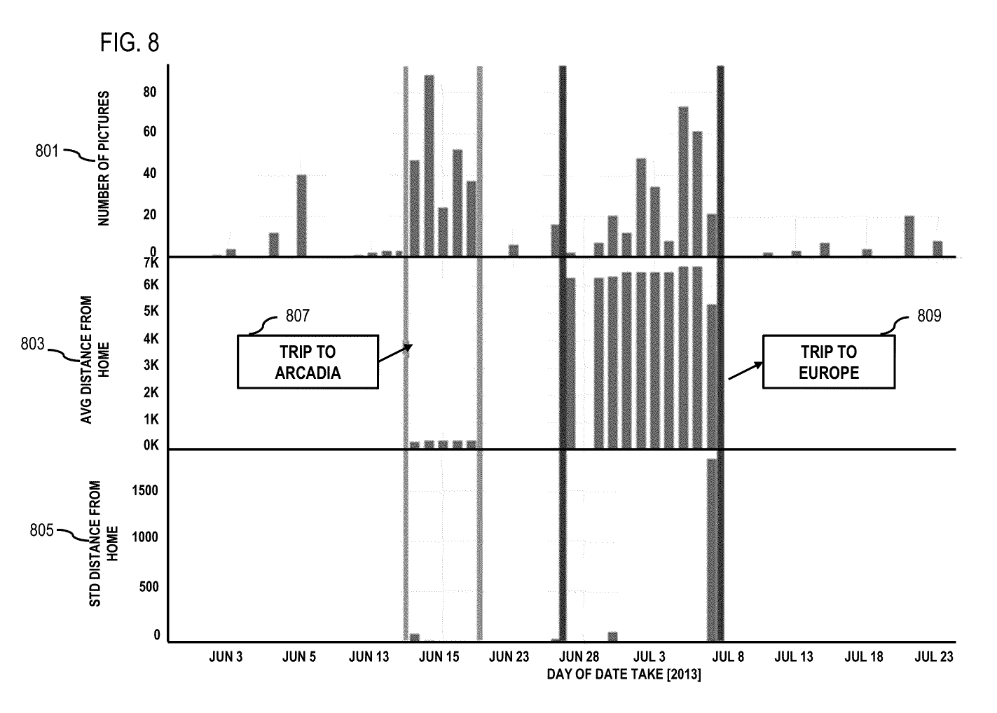

FIG. 8 is a diagram that represents the process of detecting a multi-day trip using the metadata associated with one or more images, videos, or a combination thereof, according to one embodiment. FIG. 8 is divided into three parts, namely, (i) number of pictures taken during a specific time period [801], (ii) average distance from user's home or a reference point of interest towards at least one destination [803], and (iii) standard deviation of the distance from user's home or a reference point of interest towards at least one destination [805]. In one scenario, one or more users tend to take multiple pictures during their trips as compared to their normal day routine. The classification platform 109 may calculate an average of the number of pictures taken by at least one user during his multi-day trip, and may compare the number of pictures taken during the multi-day trip with the number of pictures taken by a user in their daily life. In one scenario, the classification platform 109 may calculate an average distance from user's home or a reference point of interest towards at least one destination. Such calculation is based on an assumption that when users are on a multi-day trip, the locations where the pictures are taken are far-off from their home or from a reference point of interest (this is represented by a trip to Arcadia [807] and Europe [809]). In one scenario, the classification platform 109 may calculate standard deviation of the distance from user's home or a reference point of interest towards at least one destination. The classification platform 109 may implement this feature because one or more users does not travel as much as they do during the day of departure for a trip and the day of arrival from a trip. For example, the standard deviation from the user's home or form a point of reference may increase during the day of departure for a trip and the day of arrival from a trip. In between the trip the standard deviation for a user is low, therefore by combining the use of this feature the classification platform 109 may identify a multi-day trip.

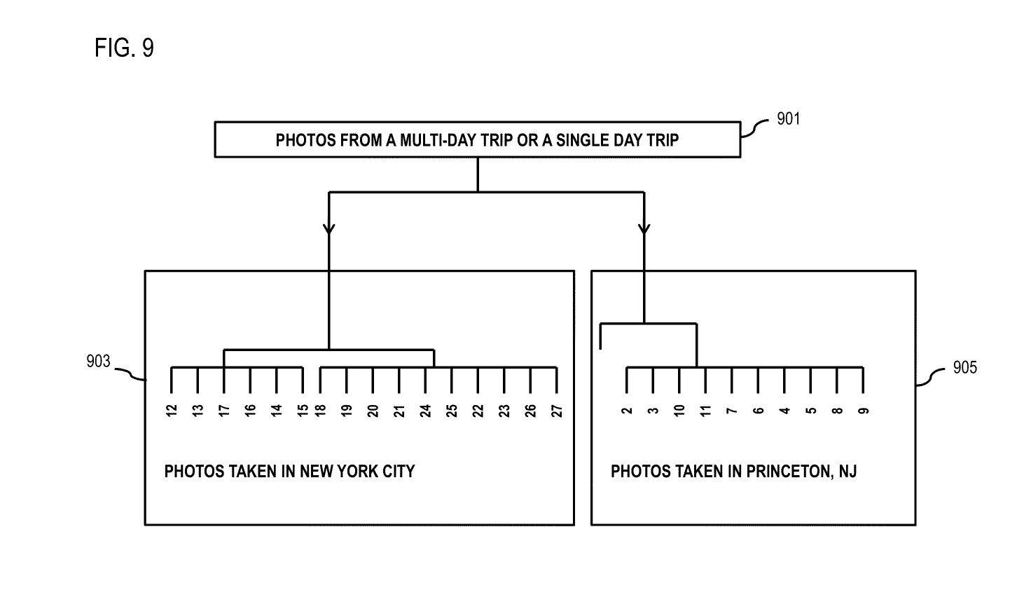

FIG. 9 is a diagram that represents hierarchical clustering of images and/or videos into different albums based on location information, according to one embodiment. In one scenario, the classification platform 109 may determine that a user is engaged in a multi-day trip or a single-day trip based on the metadata of the one or more images, one or more videos, or a combination thereof [901]. Subsequently, the classification platform 109 may cause additional sorting of the one or more images, one or more videos, or a combination thereof within a multi-day trip compilation or a single-day trip compilation based on location information. In one example embodiment, user ABC may start on a multi-day trip to New York and New Jersey, the classification platform 109 may identify the multi-day trip and may sort the one or more images, one or more videos, or combination thereof within a multi-day trip album. The classification platform 109 may further sort the one or more images, one or more videos, or combination thereof based on location information within the multi-day trip album, for instance, pictures and/or videos taken in New York [901] is saved separately from the pictures and/or videos taken in New Jersey [905].

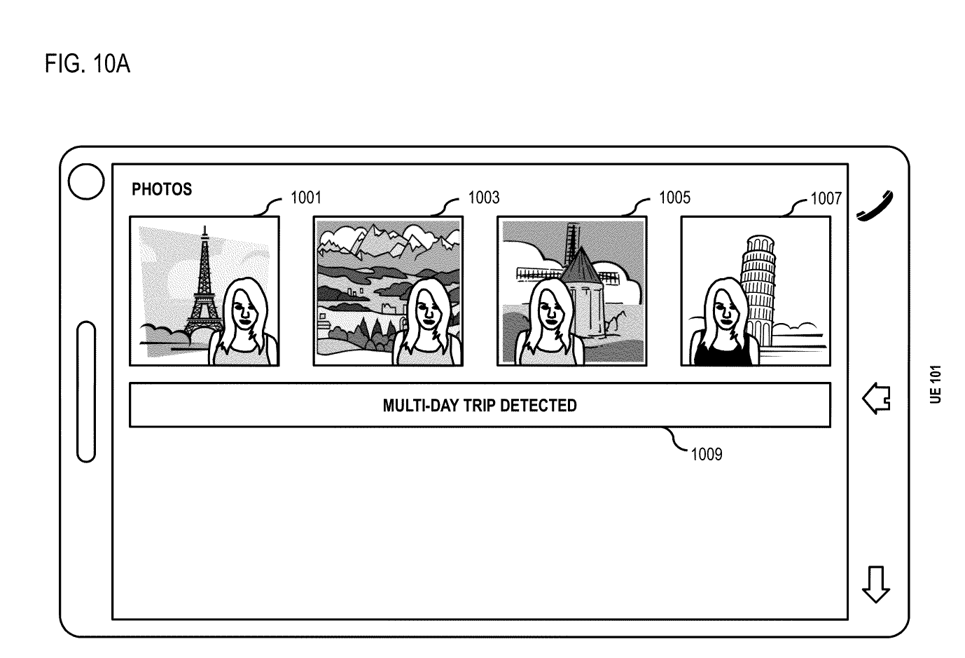

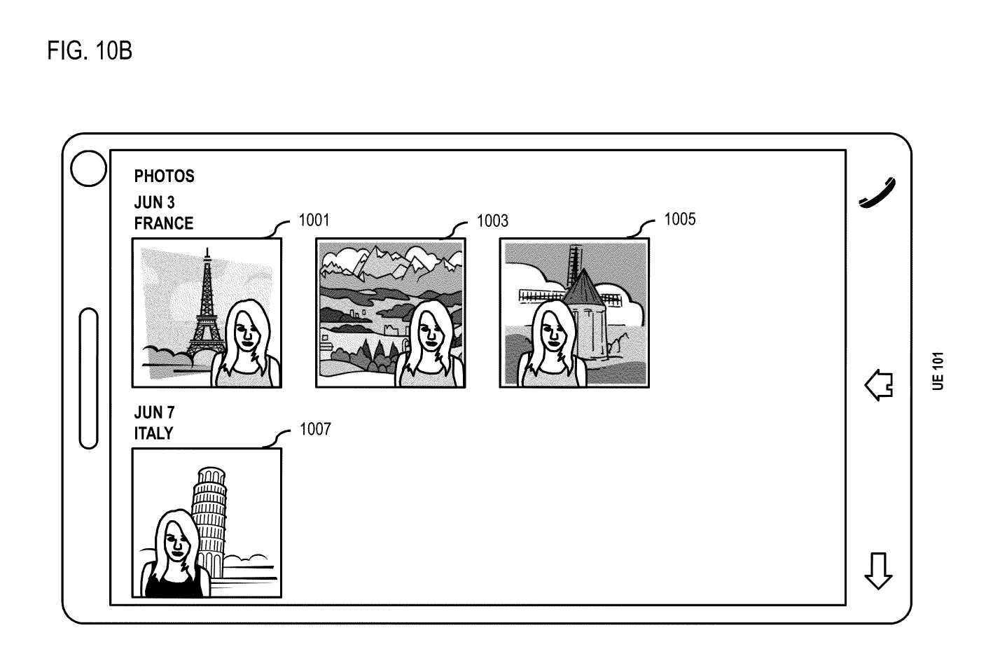

FIGS. 10 A-B are user interface diagrams that represent a scenario wherein the classification platform 109 determines a multi-day trip for at least one user, according to one embodiment. In FIG. 10A, the classification platform 109 may receive one or more images [1001, 1003, 1005, 1007] from a user, whereupon the classification platform 109 may process the metadata associated with the one or more images to determine whether it is a multi-day trip

In FIG. 10B, the classification platform 109 may further categorize the received images based on their geo-location information, for example, pictures taken in France [1001, 1003, 1005] are saved together whereas the pictures taken in Italy [1007] is saved separately.

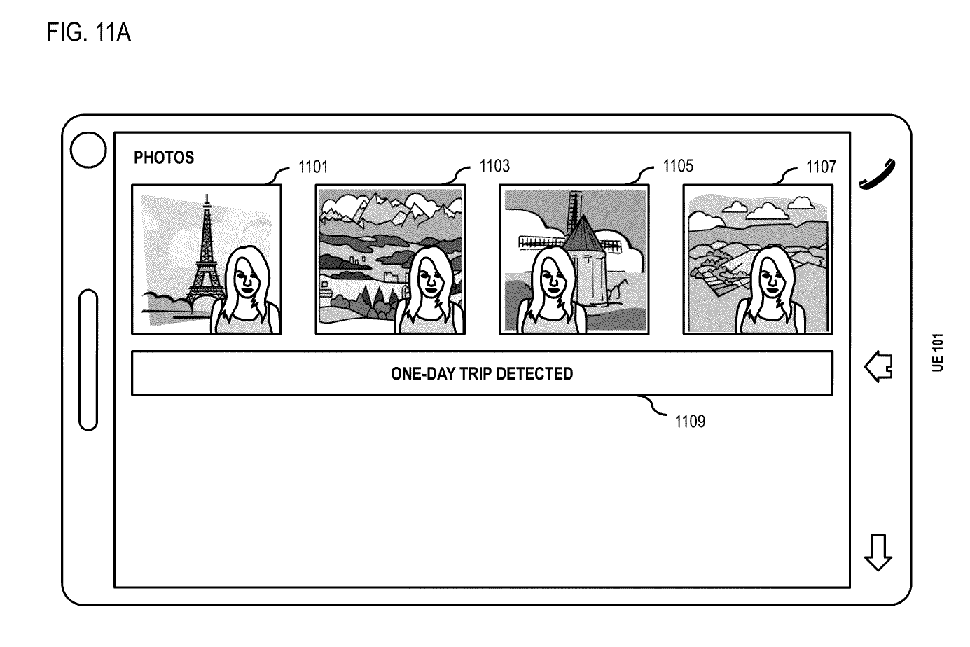

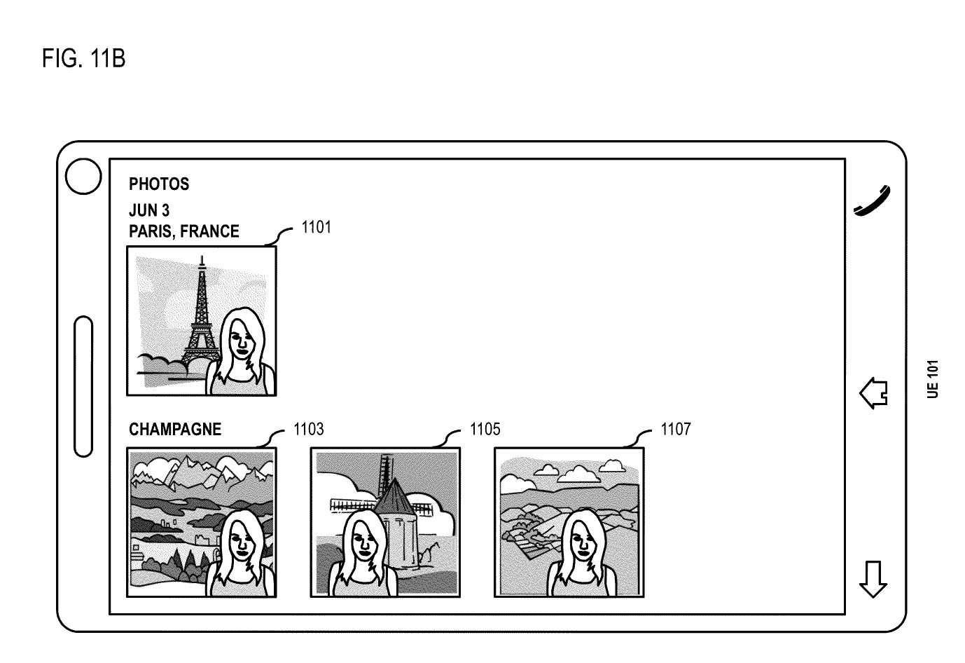

FIGS. 11 A-B are user interface diagrams that represent a scenario wherein the classification platform 109 determines a single-day trip for at least one user, according to one embodiment. In FIG. 11A, the classification platform 109 may receive one or more images [1101, 1103, 1105, 1107] from a user, whereupon the classification platform 109 may process the metadata associated with the one or more images to determine whether it is a single-day trip [11009]. In FIG. 11B, the classification platform 109 may further categorize the received images based on their geo-location information, for example, a picture taken in Paris [1101] is saved separately from the pictures taken in Champagne [1103, 1105, 1107].

The processes described herein for causing a classification of media items into a hierarchical clustering based, at least in part, on metadata, geo-location, or a combination thereof may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

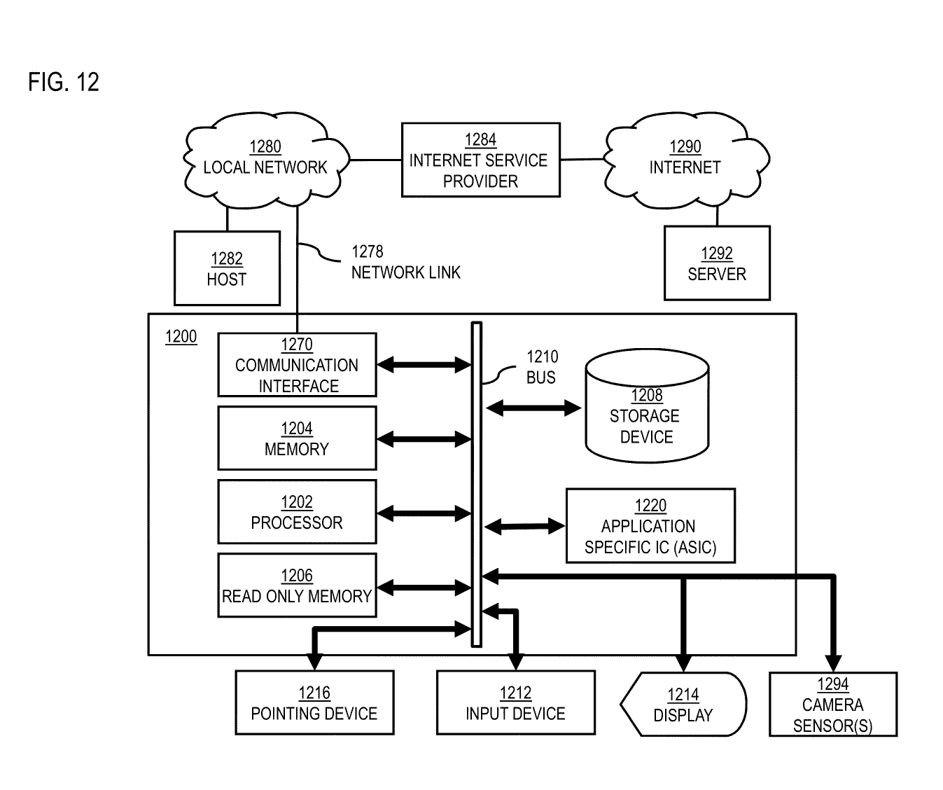

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to cause a classification of media items into a hierarchical clustering based, at least in part, on metadata, geo-location, or a combination thereof, as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of causing a classification of media items into a hierarchical clustering based, at least in part, on metadata, geo-location, or a combination thereof.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to cause a classification of media items into a hierarchical clustering based, at least in part, on metadata, geo-location, or a combination thereof. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1200 also includes a memory 1204 coupled to bus 1210. The memory 1204, such as a random access memory (RAM) or any other dynamic storage device, stores information including processor instructions for causing a classification of media items into a hierarchical clustering based, at least in part, on metadata, geo-location, or a combination thereof. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for causing a classification of media items into a hierarchical clustering based, at least in part, on metadata, geo-location, or a combination thereof, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214, and one or more camera sensors 1294 for capturing, recording and causing to store one or more still and/or moving images (e.g., videos, movies, etc.) which also may comprise audio recordings. In some embodiments, for example, in embodiments in which the computer system 1200 performs all functions automatically without human input, one or more of external input device 1212, display device 1214 and pointing device 1216 may be omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 107 for causing a classification of media items into a hierarchical clustering based, at least in part, on metadata, geo-location, or a combination thereof to the UE 101.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set or chip 1300 upon which an embodiment of the invention may be implemented. Chip set 1300 is programmed to cause a classification of media items into a hierarchical clustering based, at least in part, on metadata, geo-location, or a combination thereof, as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of causing a classification of media items into a hierarchical clustering based, at least in part, on metadata, geo-location, or a combination thereof.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to cause a classification of media items into a hierarchical clustering based, at least in part, on metadata, geo-location, or a combination thereof. The memory 1305 also stores the data associated with or generated by the execution of the inventive steps.

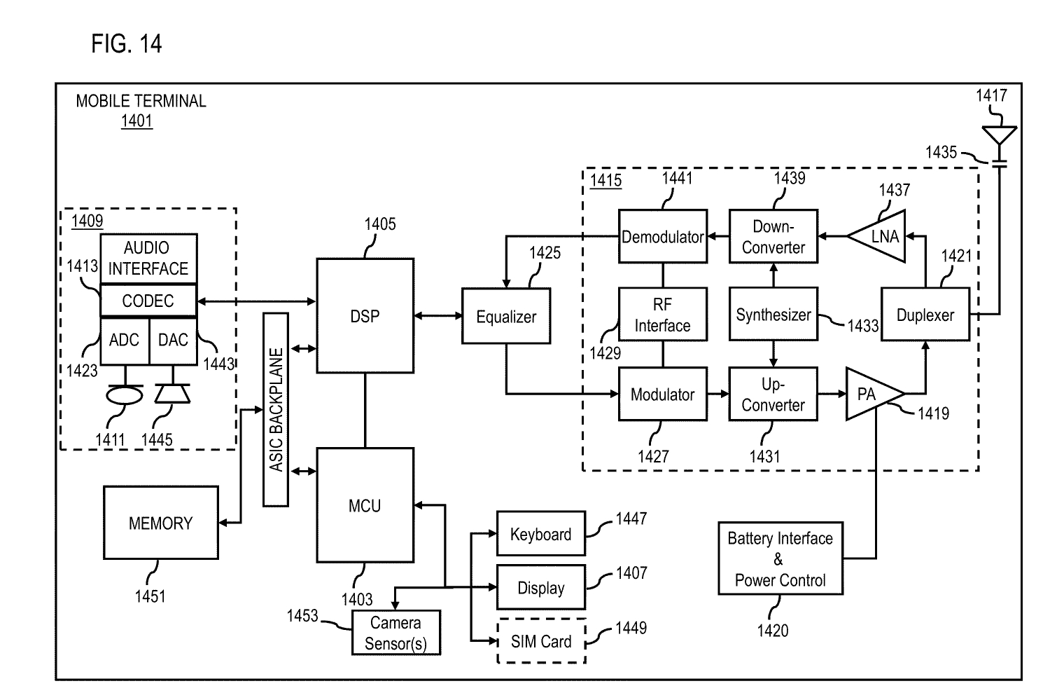

FIG. 14 is a diagram of exemplary components of a mobile terminal (e.g., handset) for communications, which is capable of operating in the system of FIG. 1, according to one embodiment. In some embodiments, mobile terminal 1401, or a portion thereof, constitutes a means for performing one or more steps of causing a classification of media items into a hierarchical clustering based, at least in part, on metadata, geo-location, or a combination thereof. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of causing a classification of media items into a hierarchical clustering based, at least in part, on metadata, geo-location, or a combination thereof. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to cause a classification of media items into a hierarchical clustering based, at least in part, on metadata, geo-location, or a combination thereof. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

Further, one or more camera sensors 1453 may be incorporated onto the mobile station 1401 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
processing and/or facilitating a processing of metadata associated with one or more media items to determine one or more observed values for one or more classification parameters, wherein the one or more classification parameters include, at least in part, a number of captured media items per day, a distance of one or more capture locations from at least one home location, or a combination thereof;
causing, at least in part, a comparison of the one or more observed values against one or more references values for the one or more classification parameters; and
causing, at least in part, a classification of the one or more media items as being associated with at least one multi-day event based, at least in part, on the comparison.

2. A method of claim 1, further comprising:
causing, at least in part, an organizing of the one or more media items into one or more albums based, at least in part, on the classification,
wherein the one or more albums are associated with the at least one multi-day event.

3. A method of claim 2, further comprising:
determining that the one or more media items are not associated with geo-location information; and
causing, at least in part, an inference of the geo-location information based, at least in part, on the classification,
wherein the organizing of the one or more media items is further based, at least in part, on the inference of the geo-location information.

4. A method of claim 1, further comprising:
processing and/or facilitating a processing of behavioral pattern data associated with one or more reference users to determine the one or more reference values, the one or more classification parameters or a combination thereof,
wherein the one or more references are engaged in at least one reference multi-day trip.

5. A method of claim 4, further comprising:
processing and/or facilitating a processing of individual behavioral pattern data associated with at least one user capturing the one or more media items to cause, at least in part, an adaptation of the one or more references values,
wherein the comparison of the one or more observed values, the classification of the one or more media items, or a combination thereof is further based, at least in part, on the adaption of the one or more reference values.

6. A method of claim 5, wherein the individual behavioral pattern data relate, at least in part, to a media capturing behavior, a media organizing behavior, or a combination thereof.

7. A method of claim 1, further comprising:
causing, at least in part, a hierarchical clustering of the one or more media items following the classification of the one or more media items,
wherein the hierarchical clustering is based, at least in part, on one or more contextual parameters; and
wherein the one or more contextual parameters include, at least in part, a geo-location parameter, a temporal parameter, or a combination thereof.

8. A method of claim 7, further comprising:
causing, at least in part, an initiation of the hierarchical clustering when the classification of the one or more media items indicates that the one or more media items is associated with at least one one-day event.

9. A method of claim 1, further comprising:
causing, at least in part, a calculation of one or more statistical metrics based, at least in part, on the one or more observed values, the one or more reference values, or a combination thereof,
wherein the comparison of the one or more observed values, the classification of the one or more media items, or a combination thereof is further based, at least in part, on the one or more statistical metrics; and
wherein the one or more statistical metrics include, at least in part, a standard deviation, a variance, or a combination thereof.

10. A method of claim 1, wherein the classification of the one or more media items further classifies the one or more media items as being associated with one or more sub-events of the at least one multi-day event based, at least in part, on the comparison.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of metadata associated with one or more media items to determine one or more observed values for one or more classification parameters, wherein the one or more classification parameters include, at least in part, a number of captured media items per day, a distance of one or more capture locations from at least one home location, or a combination thereof;
cause, at least in part, a comparison of the one or more observed values against one or more references values for the one or more classification parameters; and
cause, at least in part, a classification of the one or more media items as being associated with at least one multi-day event based, at least in part, on the comparison.

12. An apparatus of claim 11, wherein the apparatus is further caused to:
cause, at least in part, an organizing of the one or more media items into one or more albums based, at least in part, on the classification,
wherein the one or more albums are associated with the at least one multi-day event.

13. An apparatus of claim 12, wherein the apparatus is further caused to:
determine that the one or more media items are not associated with geo-location information; and
cause, at least in part, an inference of the geo-location information based, at least in part, on the classification,
wherein the organizing of the one or more media items is further based, at least in part, on the inference of the geo-location information.

14. An apparatus of claim 11, wherein the apparatus is further caused to:
process and/or facilitate a processing of behavioral pattern data associated with one or more reference users to determine the one or more reference values, the one or more classification parameters or a combination thereof,
wherein the one or more references are engaged in at least one reference multi-day trip.

15. An apparatus of claim 14, wherein the apparatus is further caused to:
process and/or facilitate a processing of individual behavioral pattern data associated with at least one user capturing the one or more media items to cause, at least in part, an adaptation of the one or more references values,
wherein the comparison of the one or more observed values, the classification of the one or more media items, or a combination thereof is further based, at least in part, on the adaption of the one or more reference values.

16. An apparatus of claim 11, wherein the apparatus is further caused to:
cause, at least in part, a hierarchical clustering of the one or more media items following the classification of the one or more media items,
wherein the hierarchical clustering is based, at least in part, on one or more contextual parameters; and
wherein the one or more contextual parameters include, at least in part, a geo-location parameter, a temporal parameter, or a combination thereof.

17. An apparatus of claim 16, wherein the apparatus is further caused to:
cause, at least in part, an initiation of the hierarchical clustering when the classification of the one or more media items indicates that the one or more media items is associated with at least one one-day event.

18. A computer-readable storage medium carrying one or more sequences of one or more instructions which, when executed by one or more processors, cause an apparatus to at least perform the following steps:
process and/or facilitate a processing of metadata associated with one or more media items to determine one or more observed values for one or more classification parameters, wherein the one or more classification parameters include, at least in part, a number of captured media items per day, a distance of one or more capture locations from at least one home location, or a combination thereof;
cause, at least in part, a comparison of the one or more observed values against one or more references values for the one or more classification parameters; and
cause, at least in part, a classification of the one or more media items as being associated with at least one multi-day event based, at least in part, on the comparison.

19. A computer-readable storage medium of claim 18, wherein the apparatus is further caused to:
cause, at least in part, an organizing of the one or more media items into one or more albums based, at least in part, on the classification,
wherein the one or more albums are associated with the at least one multi-day event.

20. A computer-readable storage medium of claim 18, wherein the apparatus is further caused to:
determine that the one or more media items are not associated with geo-location information; and
cause, at least in part, an inference of the geo-location information based, at least in part, on the classification,
wherein the organizing of the one or more media items is further based, at least in part, on the inference of the geo-location information.

21.-48. (canceled)
